(19) United States
(12) Patent Application Publication
(10) Pub. No.: US 2026/0233468 A1
(43) Pub. Date: Aug. 13, 2026

(54) Systems and Methods for Automated Deposition Additive Manufacturing

(71) Applicant: Relativity Space, Inc., Long Beach, CA (US)

(72) Inventors: Tyler Ledgett, Long Beach, CA (US); Rocco DiVerdi, Long Beach, CA (US); Alexander Weisfeld, Long Beach, CA (US); Alyssa Ishigo, Long Beach, CA (US); Vladislav Mogilevskiy, Long Beach, CA (US)

(73) Assignee: Relativity Space, Inc., Long Beach, CA (US)

(21) Appl. No.: 19/438,269

(22) Filed: Dec. 31, 2025

Related U.S. Application Data
(60) Provisional application No. 63/757,268, filed on Feb. 11, 2025.
(60) Provisional application No. 63/770,841, filed on Mar. 12, 2025.

(51) Int. Cl. B29C 64/393; B23K 9/04; B33Y 50/02

(52) U.S. Cl. CPC B29C 64/393; B33Y 50/02; B23K 9/04

(57) ABSTRACT

Systems and methods for additive manufacturing processes and structures formed thereby, and more particularly to automated deposition processes for additive manufacturing are provided.

### CROSS-REFERENCES TO RELATED APPLICATIONS

The current application claims priority to Provisional Patent Application No. 63/757,268, filed Feb. 11, 2025, and Provisional Application No. 63/770,841, filed Mar. 12, 2025, the disclosures of which are incorporated herein by reference.

### FIELD OF THE INVENTION

This disclosure generally refers to systems and methods for additive manufacturing processes and structures formed thereby, and more particularly to automated deposition processes for additive manufacturing.

### BACKGROUND

Additive manufacturing is a process by which a product or component is manufactured by adding one layer of material on top of another in a sequence or pattern that would result in a solid component being built. This method of manufacturing is commonly referred to as three dimensional or 3-D printing and can be done with different materials, including plastic and metal. There are many different processes available for implementing 3-D printing of articles, including, among others, direct energy deposition, powder bed fusion, cold spray, etc.

### SUMMARY OF THE INVENTION

Systems and methods in accordance with some embodiments of the invention are directed to systems and methods for additive manufacturing processes and structures formed thereby, and more particularly to automated deposition processes for additive manufacturing.

In some embodiments, the techniques described herein relate to a process of additive manufacturing including: providing a geometry of a component to be printed; providing a substrate; acquiring a surface geometry of the substrate; determining a series of individual deposition layers; printing the component according to the series of individual deposition layers; pausing the printing of the component with remaining unprinted individual deposition layers in the series; evaluating a physical characteristics of the component; and adjusting the remaining unprinted individual deposition layers based on the evaluated physical characteristics.

In some embodiments, the techniques described herein relate to a process, wherein the step of evaluating the physical characteristics includes comparing the physical characteristics with the geometry of the component.

In some embodiments, the techniques described herein relate to a process, further including saving adjustments to the individual deposition layers.

In some embodiments, the techniques described herein relate to a process, wherein the step of saving is performed after the step of pausing.

In some embodiments, the techniques described herein relate to a process, wherein the step of determining the series of individual deposition layers includes adjusting the geometry of the component based on a previous step of saving adjustments to the individual deposition layers.

In some embodiments, the techniques described herein relate to a process, wherein the step of determining the series of individual deposition layers includes adjusting the geometry of the component based on the surface geometry of the substrate.

In some embodiments, the techniques described herein relate to a process of additive manufacturing including: providing one or more component geometries; printing one or more articles based on the one or more component geometries; adjusting one or more print parameters; recording the adjusted one or more print parameters; and incorporating the recorded adjusted one or more print parameters into the one or more component geometries.

In some embodiments, the techniques described herein relate to a process, wherein the step of adjusting one or more print parameters occurs during the step of printing.

In some embodiments, the techniques described herein relate to a process, wherein adjusting one or more print parameters includes evaluating a physical characteristic of the one or more articles.

In some embodiments, the techniques described herein relate to a process, further including pausing printing one or more articles to evaluate the physical characteristic of the one or more articles.

In some embodiments, the techniques described herein relate to a process, further including saving the recorded adjusted one or more print parameters.

In some embodiments, the techniques described herein relate to a process of additive manufacturing including: providing a part; providing one or more component geometries to be incorporated on the part; determining a series of individual deposition patterns for each component geometry; determine a plurality of depositions, wherein each deposition includes the series of the deposition patterns, wherein the plurality of depositions incorporates a coordinated movement between a weld torch and the part; and printing one or more components on the part by switching between components according to the plurality of depositions.

In some embodiments, the techniques described herein relate to a process, further including pausing the printing of one or more components to evaluate a physical characteristic of each component.

In some embodiments, the techniques described herein relate to a process, further including evaluating the physical characteristic each component to adjust one or more print parameters for each component.

In some embodiments, the techniques described herein relate to a process, wherein the physical characteristic of each component is saved.

In some embodiments, the techniques described herein relate to a process, wherein the saved physical characteristic of each component is compiled to form a print file for each component.

In some embodiments, the techniques described herein relate to a process, wherein the print file is incorporated into the component geometry.

In some embodiments, the techniques described herein relate to a process, wherein the print file is appended alongside the component geometry.

In some embodiments, the techniques described herein relate to a process, wherein the coordinated movement includes tilting the substrate.

In some embodiments, the techniques described herein relate to a process, wherein the coordinated movement includes tilting the weld torch.

Additional embodiments and features are set forth in component in the description that follows, and in component will become apparent to those skilled in the art upon examination of the specification or may be learned by the practice of the disclosure. A further understanding of the nature and advantages of the present disclosure may be realized by reference to the remaining portions of the specification and the drawings, which forms a component of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1 illustrates a process diagram of an iterative additive manufacturing system in accordance with an embodiment.

FIG. 2 illustrates a method of additive manufacturing in accordance with an embodiment.

FIG. 3 illustrates a process of additive manufacturing in accordance with an embodiment.

FIG. 4 illustrates an example of additive manufactured components printed in accordance with an embodiment.

FIG. 5 schematically illustrates a system for printing multiple components on multiple build plates.

FIGS. 6A to 6H illustrate an example of an additive manufacturing in accordance with an embodiment.

### DETAILED DESCRIPTION OF THE INVENTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

Additive manufacturing (AM) is the process of creating an object by building one layer at a time. This process can be contrasted with conventional molding or casting techniques, in which components of an object are created via a premade mold or cast of the object and then assembled together.

Although it may have some benefits compared to conventional techniques, additive manufacturing creates challenges in ensuring that the final component has adequate engineering properties. Further, additive manufacturing is a genus term that actually references a number of different techniques, including, for example, binder jetting (BJT), cold spray additive manufacturing (CS), directed energy deposition (DED), wire arc additive manufacturing (WAAM) or directed energy deposition-arc (DED-arc), material extrusion, and powder bed fusion (PBF), and sheet lamination, including laminated object manufacturing (LOM) and ultrasonic additive manufacturing (UAM), among others. Each of these species of the additive manufacturing genus has different capabilities in terms of material limitations, overall component size attainable, individual feature size available, etc. ; each has unique challenges related to engineering properties.

In AM techniques, deposition patterns may be pre-determined, and deposition layers may be deposited based on the deposition patterns. Aspects of this disclosure provide for deposition layer sequencing techniques directed towards WAAM, however, it should be understood that the automated deposition AM techniques disclosed herein are applicable to various AM techniques. WAAM specifically is a process in which a metal wire is provided from a tip of a welding torch while energy is applied to the metal wire and the resulting arc melts the wire to allow deposition to be layered in the desired shape of the component being manufactured. The material is deposited in a series of patterned layers, wherein the stacked layers results in the desired three-dimensional shape. The pattern of each layer may be consistent across the entire shape. The material is deposited in the desired pattern based on the specific directions the welding torch is directed to move in. The specific directions may be designed in a computer program that directs the welding torch to apply heat, move, and remove heat as depicted in the programmed pattern.

Distortions and non-planar depositions are often unavoidable in any given AM process. Distortions and non-planar depositions may result from process excursions, such as changes in the movement of the system relative to itself, equipment calibration, wear on the system that may result in unknowable changes in process parameters, and/or manual process intervention such as changes in feedstock, consumables, environment, and/or instabilities in the process.

In WAAM processes, material is deposited starting with the initial arc. The start point of each deposition layer is when the heat is applied to the material to begin the deposition of the material. The start of a WAAM process deposition layer can result in component discontinuity. Non-planar deposition includes high profiles in the component structure caused by excess material pooling during the initial heating of the material. Non-planar deposition also includes low profiles in the component structure formed through undeposited material, wherein the welding torch began moving according to the pattern before the material was sufficiently heated to be deposited. Similarly, in WAAM processes, the end point is when heat is removed from the material to end the deposition of the material. As with the start point, the end point can also result in component defects due to the excess pooling and/or inadequate deposition of material when the heat source is removed. In a WAAM process a single layer may consist of multiple start points and stop points, due to the deposition of a perimeter pattern and a separate deposition of an in-fill pattern. Furthermore, pooling or cavities within each layer can result in the finished component having an irregular or bumpy outer surface. The layer defects can accumulate within the successive layers resulting in a distorted finished component. The start point and end point of each layer may result in a pooling and/or cavity of material. Additionally, defects and distortions can result from the fusion between deposition layers. Newly deposited deposition layers adhere to previous deposition layers through the molten material deposited and the molten material of the previous layer. As the molten material is deposited, it heats the previous layer resulting in the deposition layers fusing together. As the previous layer and deposited layer are melted together, uneven heating across the component can result in sagging or bumping. When the previous layer has been recently heated, sagging may occur when reheated during the deposition of the next layer. When the previous layer has cooled, bumping may occur due to lack of adequate melting of the previous layer.

Adjustments to the AM print process may be made in response to defects and distortions during the printing process. These adjustments may be manually decided on and entered by a technician. As such, each resulting AM component is in a sense uniquely handmade, and may contain unique deviations from CAD that must be quantified for the sake of reproducibility. Automation of adjustments during a printing process in accordance with various embodiments of the disclosure allows for reproducibility of AM components. In various embodiments, processes incorporating such automated adjustments improves the speed at which the AM components may be produced, and even reproduced. The automated AM system in accordance with many embodiments also allows for the quality of the components to continually be improved. In many embodiments the printing process data of each print can be continually saved and fed back into the printing process of subsequent prints. As a result, the automated AM system in accordance with such embodiments continues to improve the quality of each subsequent component through iteratively, or cumulatively, altering the print (e. g, through adjustments to the pattern, the parameters, and so on) to incorporate adjustments to account for defects and distortions. The AM system according to such embodiments also allows for subsequent prints to account for defects and distortions of previous prints and removes them in the subsequent prints by accounting for the previous adjustment made. As more components are printed, the AM system in accordance with various embodiments reduces the number of defects and the severity of distortion as the defects and distortions are progressively accounted for. The AM system in accordance with many embodiments further improves quality control of AM components. AM components produced by manual adjustments for each print must be individually subjected to quality control. In the automated AM system in accordance with embodiments where the quality of components is iteratively improved, the quality of subsequently printed components is at least the standard of the previous print. For example, in applications where a component must meet a quality control standard, such as flight qualification for a rocket launch vehicle, all components printed after a qualified component are expected to meet, if not exceed, the qualification standard.

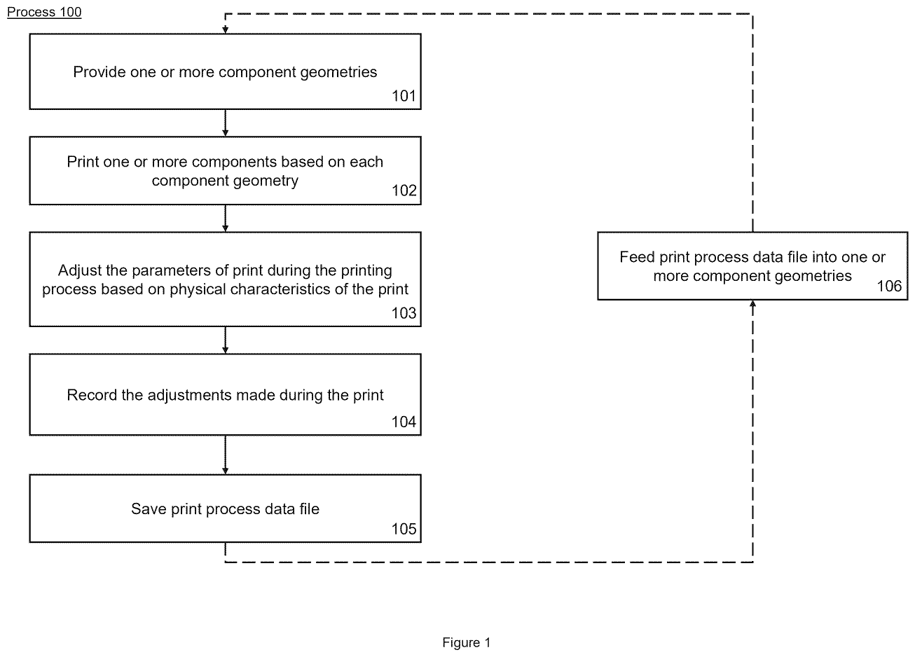

Aspects of this disclosure are directed towards an iterative AM system. An AM print may be configured to produce one or more components. After the one or more components have been printed defects and distortions may be identified as described above, as well as in “Additively Manufactured Combustion Chambers, Manifold Structures and Hybrid Additive Processes Related Thereto” U.S. application Ser. No. 18/515,033, hereby incorporated by reference in its entirety. In a subsequent print of the same or similar components, adjustments to the printing process and parameters, including the coordinated movement of the build plate and weld torch, and including wire feed speed, welding voltage, welding current, and/or other parameters, may be adjusted to remove the defect and/or distortion. In some embodiments, the AM system may be configured to make adjustments during the printing process of the first print as defects and/or distortions are identified as described above. The AM system saves the entire printing process data file and incorporates the adjustments made into subsequent prints of the same or similar component configuration. As subsequent printing processes occur, the AM system iteratively collects the printing process data file and iteratively refines, or updates, the printing process and/or parameters, such as the coordinated movement, and such as the wire and/or welding details. This iterative process is described in FIG. 1.

Process 100 provides (101) one or more component geometries. The component geometries, in many embodiments, are the individual geometries for each component when printed. The printed component can have a final geometry of the printed component. In some embodiments, the component geometry comprises a plurality of deposition layers to be printed to form the printed component. The component geometry can comprise the print parameters (for example, a first version of the print parameters) to be executed for each deposition layer.

Process 100 prints (102) the component based on the component geometry. AM techniques can be utilized to print the component such that each deposition layer is deposited according to the component geometry and print parameters. Print parameters can direct the deposition of material within the AM process. In many embodiments, print parameters can be the metal wire feed speed, the energy applied to the metal wire, the speed of the deposition head of the AM process, the direction of movement of the deposition head, and/or the rotation of the deposition head and/or component.

Process 100 adjusts (103) one or more print parameters during the printing process. In some embodiments, one or more print parameters are adjusted based on physical characteristics of the component during the printing process. The component can be evaluated during the printing process. In many embodiments, the print is paused to allow for the component to be evaluated. Evaluating the component can check whether the component is within dimensional tolerances and/or has suitable surface finishes. For example, the component can be assessed to determine if it is within the required dimensions of the component geometry. In various embodiments, adjustments to the print parameters can be made to bring a component within the required dimensional tolerances of the component geometry.

Process 100 records (104) the adjustments made to the print parameters during the printing process. The recorded adjustments keep track of adjustments made in the printing process, so the specific print parameters used for a specific printing process are known. In many embodiments, process 100 saves (105) the recorded adjustments in a print process data file. The print process data file keeps a record of the specific printing process that can be used to trace the component.

Process 100 optionally feeds (106) the saved print process data file into the component geometry. By feeding the print process data file into the component geometry, the component geometry can be updated to account for adjustments made to reduce the number of adjustments in future prints of the component. In many embodiments, reducing the number of adjustments can improve the efficiency of printing a component because less adjustments are being made during the printing process. Feeding the print process data file into the component geometry can refine the component geometry to improve the quality of subsequent printed components. In several embodiments, the record of the adjustments added to the component geometry tracks the changes in print parameters to allow for quality metrics to be tracked. In one embodiment, such feeding can involve incorporating the print process data file directly into print parameters stored in the component geometry (thus altering the original component geometry), while in another embodiment such feeding can involve appending the print process data file as a sidecar data file alongside the component geometry (thus leaving the original component geometry unchanged).

Aspects of this disclosure are directed towards a process of AM comprising providing a build plate or a substrate, acquiring the build plate's or the substrate's surface geometry, determining a series of individual deposition layers, and printing a component according to the series of individual deposition layers. The disclosure herein may optionally incorporate printing the component in increments, wherein the print is paused after a number of layers and evaluated. Based on the physical characteristics of the partially printed component, the print parameters may be adjusted to prevent distortions and/or defects in the finished component. The process may further comprise saving the printing process data file such that subsequent print of a same or similar component configuration build on the printing process data learned from prior prints.

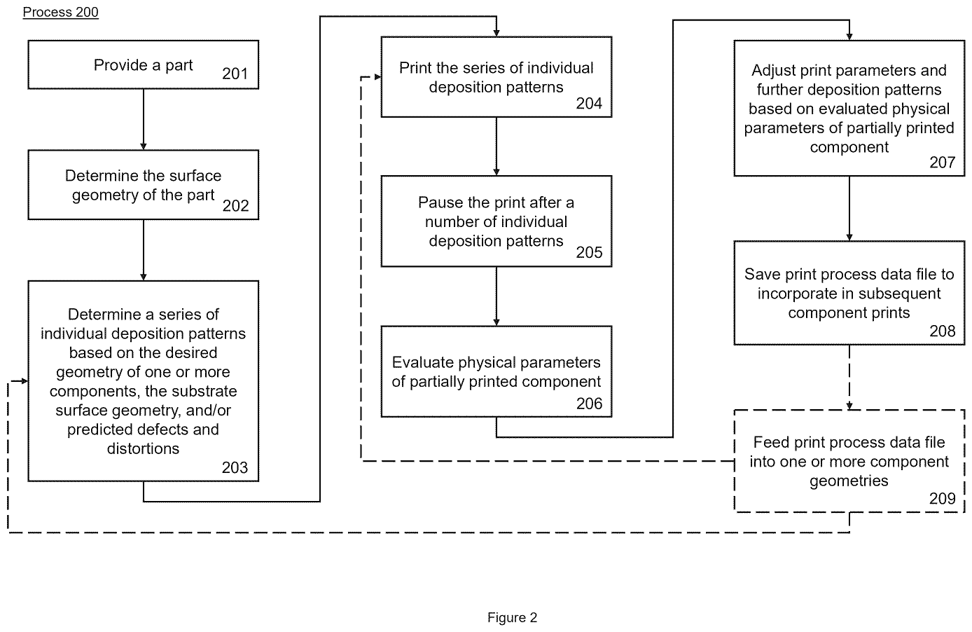

In some embodiments, the substrate provided may be another part or component. FIG. 2 depicts process 200 describing a process to print a component on a part in accordance with several embodiments. Process 200 provides (201) a part. The part provided can serve as the build plate for the component. In many embodiments, one or more components can be printed on the provided part.

Process 200 determines (202) the surface geometry of the part. The provided part may have a complex and/or irregular surface geometry. The provided part may be curved comprising a single curve or a series of curves. The part may have an angled surface geometry. The part may have a series of corners such as a zig zag. The part may have one or more surface geometries. The provided part may have a bumpy or rough surface texture.

Process 200 determines (203) a series of individual deposition patterns based on the desired geometry of each component. In many embodiments, process 200 accounts for the surface geometry of the part at the location of the component. For example, if a location of the component is on a sloped surface of the part, but the component desired geometry is level, process 200 determines the series of individual deposition patterns such that the resulting component is level. In several embodiments, process 200 accounts for predicted defects and/or distortions within the component. Predicted defects and/or distortions can arise from previous in-print data for the component. In many embodiments, more than one component is printed on the part. Process 200 can determine a series of deposition patterns of more than one component. In various embodiments, the series of deposition patterns comprises deposition layers from more than one component such that each component is partially printed between deposition of another component.

Process 200 prints (204) a series of individual deposition layers. In many embodiments, the series of deposition layers are printed by an AM technique. The AM technique can print each deposition layer according to the deposition pattern determined within the series. In some embodiments, more than one component is printed such that each component is at least partially printed between another component. In many embodiments, process 200 is configured to move the weld head of the AM technique between components according to the series of deposition layers.

Process 200 pauses (205) the print after a number of deposition layers have been printed. In some embodiments, process 200 pauses the print after a set number of deposition layers have been deposited. In other embodiments, a technician can pause the print.

Process 200 evaluates (206) physical parameters of the partially printed component. The partially printed component can be evaluated while the print is paused. In some embodiments, the physical parameters of the partially printed component are evaluated to compare to the desired finished print geometry. Evaluating the component can check whether the component is within dimensional tolerances. For example, the component can be assessed to determine if it is within the required dimensions of the component geometry.

Process 200 adjusts (207) print parameters to bring the component within the required dimensional tolerances of the component geometry, or to otherwise improve a characteristic of the component. In many embodiments, print parameters to be adjusted can be the metal wire feed speed, the energy applied to the metal wire, the speed of the deposition head of the AM process, the direction of movement of the deposition head, and/or the rotation of the deposition head and/or component.

Process 200 saves (208) the adjustments in a print process data file. The print process data file keeps a record of the specific printing process that can be used to trace the component. In many embodiments, the print process data file further comprises data related to the deposition layers of the printed component. The print process data file can be identified for each component, such that even though the component may be at least partially printed between the printing of another component, the entire data for the printed component can be saved. In certain embodiments, the entire print process data file for the component can be analyzed to assess the quality of the print of the component. Printing at least a portion of each component can form zones within the component, wherein each zone is printed between printing another component. Each zone within the component print process data file can be identified and assessed.

Process 200 optionally feeds (209) the print process data file into the component geometry for each component. In many embodiments, the print process data file comprises adjustments made to print parameters for each component. In one embodiment, such feeding can involve incorporating the print process data file directly into print parameters stored in the component geometry (thus altering the original component geometry), while in another embodiment such feeding can involve appending the print process data file as a sidecar data file alongside the component geometry (thus leaving the original component geometry unchanged). Process 200 can feed (209) the print process data file into the component geometry to determine (203) the series of subsequent deposition layers. Alternately, or additionally, process 200 can feed (209) the print process data file into the component geometry to print (204) the series of individual deposition patterns.

Aspects of this disclosure are directed towards an AM process to print one or more features on a build plate, wherein a first feature is partially printed before switching to one or more additional features and back again based on an order of interleaved deposition patterns for the plurality of features. In some embodiments, the AM process is used to print one or more features on a part. In many embodiments, a planning software may be used to print WAAM features on a part according to the order of interleaved deposition patterns. The features are constituted in the order of interleaved deposition patterns as a series of individual deposition patterns. The interleave series of individual deposition patterns from the one or more features can print at least a portion of a first feature, then at least a portion of one or more additional features before returning to print at least a second portion of the first feature. In many embodiments, planning the order of deposition patterns may interleave deposition patterns from the series of deposition patterns of multiple features to manage heat input so the entire set of features can be printed faster overall. Accordingly, while a portion of the layers from the individual deposition patterns of one feature are cooling, layers from the deposition patterns of another feature can be printed such that the other feature being printed does not affect the cooling of the first feature. In many embodiments, planning the order of deposition pattern compiles and sequences multiple individual deposition patterns of different features together. Accordingly, the individual features are not printed sequentially, wherein each feature is printed in a continuous start to finish fashion. Planning the order of the deposition patterns thus incorporates complexity prior to the beginning of the printing process by sequencing the individual deposition patterns of each feature as an individual deposition layer, wherein the sequence of deposition layers move from one feature to another. In some embodiments, a deposition may comprise multiple deposition patterns of a single feature to be printed together. In some embodiments, for a WAAM print, a first deposition comprises applying the arc, printing a series of deposition layers, removing the arc; then a second deposition comprising moving the weld torch to a second feature, applying the arc, printing a series of deposition layers of a second feature, and removing the arc. In some embodiments the individual depositions may have a different number of deposition patterns wherein the duration of the individual deposition varies. In some embodiments, an individual deposition may not be a unitary sequence, wherein the individual deposition does not have a “complete” instruction that turns off the control system. Traditionally, the end of each deposition ends with a “complete” instruction and a next deposition is manually determined. The process, in accordance with several embodiments, allows an individual deposition to be completed, the weld torch repositioned and/or retracted, and continue another path of a different feature. Planning the order of deposition patterns, in several embodiments, includes logic about transitioning from one feature to another that assumes part positioning. In some embodiments, the part may have a rotary-style positioner, and the weld torch is configured to retract to a height radially outwards to ensure clearance from the part during repositioning to a different feature.

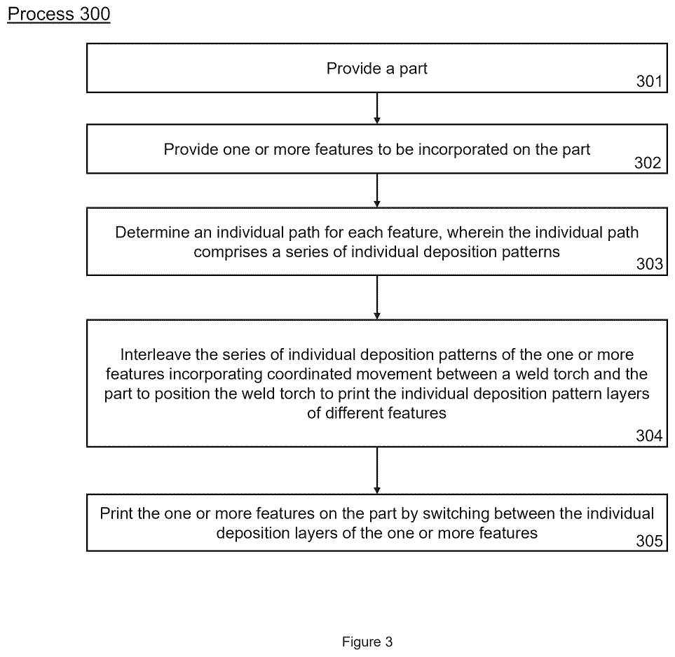

FIG. 3 depicts a process diagram of a master path process. Process 300 provides (301) a part and/or build plate. In many embodiments, one or more components are printed directly on another part. In some embodiments, the part can be configured as a build plate for one or more components. The part can be mounted on a movable robot arm to allow the part to be rotated and/or moved during the printing process.

Process 300 provides (302) one or more features to be incorporated on the part. In various embodiments, one or more components form one or more features to be added to the part. The part can be manufactured separately for the one or more features to be subsequently incorporated. In some embodiments, the part is configured to support one or more features at different locations on the part.

Process 300 determines (303) a plurality of deposition patterns for each of the one or more features. In many embodiments, the plurality of deposition patterns can be serially deposited to form the feature. Each feature can have an individual plurality of deposition patterns.

Process 300 interleaves (304) the deposition patterns for each feature. In several embodiments, process 300 interleaves the deposition patterns of different features such that the deposition patterns of different features are configured to be in series. By interleaving, the series of deposition patterns can switch between one or more features during the printing process. In many embodiments, process 300 incorporates movement of the weld torch of the AM technique to allow movement between features according to the order of the deposition patterns. In some embodiments, process 300 incorporates movement of the part to position the part with respect to the weld torch according to the order of deposition patterns. Process 300 can coordinate movement of the weld torch and the part according to the order of deposition patterns. By determining an order of interleaved deposition patterns, the printing process can be planned prior to beginning the printing process. In many embodiments, planning the printing process can reduce technician intervention, such that the technician does not need to initiate the switch between printing features.

Process 300 prints (305) one or more features on the part according to the order of deposition patterns within the series. The weld torch can print each deposition layers according to the order of interleaved deposition patterns to print the one or more features on the part. In many embodiments, printing the one or more features comprises moving the part and/or weld torch to switch between printing each feature according to the series of interleaved deposition patterns. By printing the features according to the order of interleaved deposition patterns, a technician does not need to select the next series of deposition layers for each feature. Without a technician selecting each series of deposition layers, the time to print a plurality of features according to the order of interleaved deposition patterns can be reduced. In many embodiments, reducing the time can allow one or more features to be printed within technician shift schedules.

In WAAM processes, the feedstock wire is a consumable electrode and the electricity is transferred through the consumable feedstock wire to deposit the material. Further, in WAAM prints the parameter development for a given feature geometry is not necessarily transferable to other feature geometries. Accordingly, a process using ordered deposition patterns may load new parameters for each feature, pattern, and/or deposition layer. In many embodiments, ordered deposition pattern processes may further incorporate heat management as different features are printed based on the sequenced paths. In certain embodiments, ordered deposition pattern processes can determine efficient switches between features. Efficient movement between features during printing can reduce the time of the printing process and/or thermal load. Ordered deposition patterns can account for the thermal load of the component and/or build plate to improve print quality.

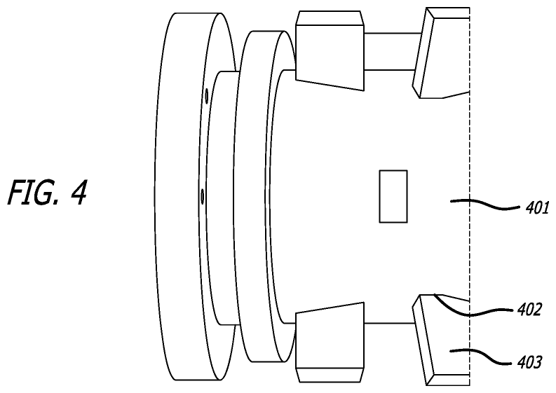

Aspects of this invention are directed towards determining a series of deposition layers based on the desired feature's physical parameters and additional external factors such as the build plate geometry and predicted defects and distortions. In some embodiments the build plate geometry, or a previously-printed part serving as a build plate or build substrate, is curved but the desired feature has flat edges. In many embodiments, the determined series of individual deposition layers accounts for the curved build plate. The determined series of deposition layers may adjust the area of the layer deposited. FIG. 4 depicts an AM feature deposited on a curved previously-printed part 401. The initial deposition layers 402 have a smaller area than the final deposition layers 403. In some embodiments, the system comprises an image sensor. The process comprises determining the surface geometry of the build plate. The surface geometry of the build plate is incorporated in the determination of the series of deposition layers.

An automated AM system may comprise movable features. The build plate may be mounted on a moveable (including but not limited to) platform, track, pulley system, and/or arm. The weld torch and/or feedstock may be mounted on a movable (including but not limited to) platform, track, pully system, and/or arm. In some embodiments, the system is configured to move the build plate and/or the weld torch during the printing process. The movement of the build plate and/or weld torch may be coordinated by the AM system. The AM system may coordinate the movement and orientation of the build plate and weld torch simultaneously. In some embodiments the AM system has a dual-axis positioner orientation, wherein the weld torch orientation and position is on a separate axis than the build plate orientation and position. The coordinated movement can improve efficiency and the quality of the print. In some embodiments, more than one feature may be printed during a single print process. The coordinated movement between the build plate and the weld torch allows the efficiency of the deposition to be improved and ensures quality through optimizing the positioning of the build plate with respect to the weld torch. In several embodiments, the individual deposition layers may vary based on movement of the build plate and/or weld torch. In some embodiments, the movement of the build plate and/or weld torch is pre-determined. In some embodiments, the movement of the build plate and/or weld torch is adjusted during the printing process. In many embodiments, the movement of the build plate and/or weld torch is controlled by a technician. A technician may manually adjust the position and movement of the build plate and/or weld torch based on a pre-determined path and/or in-print adjustments. In some embodiments, the movement of the build plate and/or weld torch may be automated. The build plate and/or weld torch may be programmed to move based on a pre-determined path and/or during the printing process. The coordinated movement between the build plate and/or weld torch may be as described in “Control Architecture for Additive Manufacturing Robotic Systems” U.S. patent application Ser. No. 18/791,302, “Modular Metal 3-D Printer Build Plate” U.S. patent application Ser. No. 18/352,995, “Systems for Horizontal Additive Manufacturing and Methods Thereof” U.S. patent application Ser. No. 18/352,992, “Additive Manufacturing Modular End Effector Assembly” PCT Application No. PCT/US2023/076486, and “Printing Heads and Associated Methods” U.S. patent application Ser. No. 18/330,987, hereby in their entireties incorporated by reference.

In some embodiments, there may be more than one build plate provided in the system. In case there are multiple build plates, the multiple build plates may be the same build plate. Alternately, the multiple build plates may be different build plates. In various embodiments, one or more weld torches may be configured to move between multiple build plates to print multiple components within a single print session. The multiple components printed on the multiple build plates may be the same component. The multiple components printed on the multiple build plates may be different components. The incorporation of more than one build plate allows for increased efficiency to print low volume components quickly, particularly when the multiple components printed are different components. The ordered deposition pattern system described herein may be configured to print multiple different components through ordered, partial deposition. The ordered deposition pattern system may be configured to print multiple different components on different build plates to allow for production of various components (at low volume for each individual component) at high production manufacturing rates, by producing multiple components according to a single order of deposition patterns. In some embodiments, the multiple components may be printed with the same material. In several embodiments, the weld torch is configured to switch between various feed stock materials such that the multiple components printed are made of different materials. In various embodiments, the multiple build plates may be positioned on a moveable device. The moveable device may be a (including but not limited to) platform, track, conveyor belt, build arm, cart, pulley system, carousel, and/or rails system. The multiple build plates may optionally be attached to the moveable device by (including but not limited to) mounting, bolting, clamping, and/or tying. The moveable device may comprise multiple discrete moveable platforms to hold one or more build plates. For example, one or more build plates may be clamped to one or more carts. The one or more carts may further be mounted on a track, such that the carts reposition the build plates along the track. The one or more moveable devices may further be configured to independently incorporate coordinated movement as configured by the order of deposition patterns as described herein, including but not limited to tilting, rotating, and/or translocating. In several embodiments the one or more moveable devices may be configured to reposition the multiple build plates with respect to another moveable device, or with respect to the weld torch, or with respect to both, such that the weld torch is able to print multiple components on the multiple build plates. In several embodiments, the multiple build plates are commonly grounded. In some embodiments, the common grounding is through connection with the moveable device.

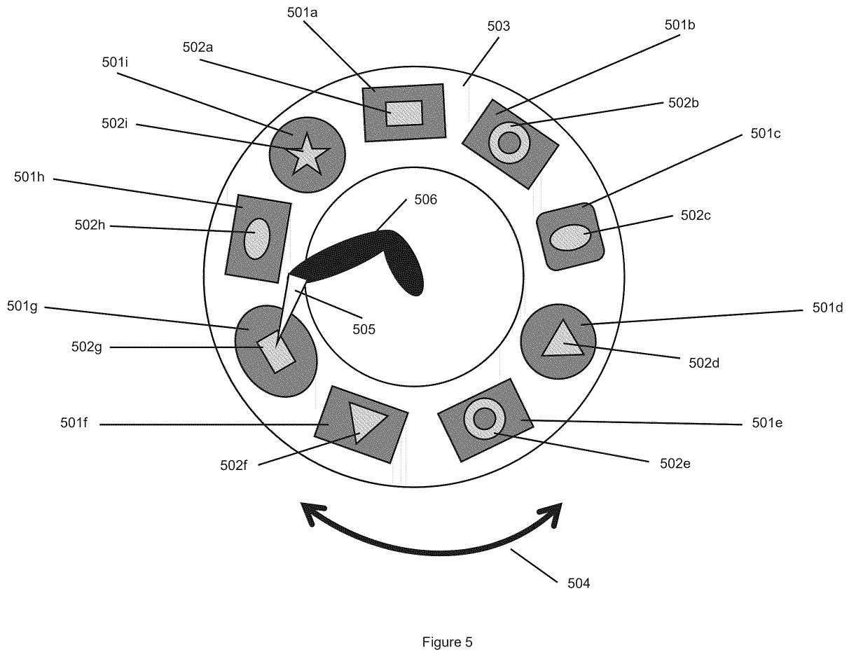

FIG. 5 provides an example of multiple build plates 501a-501i configured to print different components 502a-502i. The build plates 501a-501i may have varied characteristics. The build plates can have the same characteristics (e.g., 501a and 501b) or different characteristics (e.g., 501d and 501h). Multiple components 502a-502i may be manufactured on respective build plates 501a-501i. In many embodiments, more than one component on a single build plate. The multiple components manufactured may be entirely homogeneous, entirely heterogeneous, or a combination of both. As depicted in FIG. 5, component 501a and component 501b have different geometries. The one or more build plates may be in connection with a positioner such as moveable platform 503. As depicted in FIG. 5, the movable platform 503 is circular to allow the build plates 501a-501i to be rotated such that each build plate 501a-501i is brought near the weld torch 505. The moveable platform 403 may be rotated in either direction 504, or the moveable arm 506 may be moved, or both may be rotated and moved, as configured by a master path system according to the techniques discussed herein. In particular, even if the geometry, parameters, and other characteristics of components 502a-502i and/or of build plates 501a-501i have been created in isolation from each other, a master path system can generate a master path according to which weld torch 505 can additively manufacture all of components 502a-502i in a single operational run, according to the techniques discussed herein. In FIG. 5, the weld torch 505 is positioned within a space defined by the movable platform 503. It should be understood the weld torch 505 and/or moveable arm 506 may be positioned next to the moveable platform 503, positioned off center within the moveable platform 503, and/or may be positioned above the moveable platform 503. The weld torch 505 may be in connection with a moveable arm 506 to allow the weld torch 505 to change position and/or height with respect to the build plates 501a-501i. The rotation of the moveable platform 503 allows the weld torch 405 to print sequences of the multiple components 502a-502i according to the master path by switching between the build plates 501a-501i, without requiring an equivalent rotation of moveable arm 506. It should be understood that the techniques discussed herein can be used to generate master paths for building multiple homogenous or even heterogenous components in a single operational run, regardless of the type of additive weld torch, moveable arm, and positioner used.

Various AM features may be produced using more than one wire feed type. One or more AM features may be produced using multiple types of wire feed. Some AM features switch from a first feed material to a second feed material and finish with the first feed material. An automated AM system may utilize an automatic feed material system as described in “Additive Manufacturing Using Multiple Metallic Materials” U.S. patent application Ser. No. 18/607,251, hereby incorporated by reference in its entirety.

In various embodiments, the series of individual deposition layers is based on the physical measurements and/or parameters of the desired feature and predictions of defects and distortions. In some embodiments, the determination of deposition layers accounts for predicted defects and distortions. As described above, some distortions and defects are inherent in AM features. Since some defects and distortions can be predicted, alterations between deposition layers can counteract these predicted defects and distortions. Defects and distortions in individual layers may not result in significant deformations of the finished feature. However, when a defect or distortion accumulates in a similar spot across multiple layers, the finished part exhibits significant sagging and/or bumping. In many embodiments, the determination of a series of deposition layers can account for the accumulation of defects. The individual deposition layers within the series may be rotated to adjust the start and end point to prevent accumulation of defects inherent in the start and end point of AM techniques. The individual deposition layers within the series may be programmed to deposit adjust based on a wavy surface deviation from the original CAD to account for distortions and/or non-planar deposition profiles.

An automated AM system in accordance with various embodiments may comprise a path distortion and control system. The path distortion and control system may be used to predict potential defects or distortions within a print. The path distortion and control system may be used to detect defects as they form during the printing process. The path distortion and control system can correct the detected defects and distortions within a print during the printing process. Defects and distortions can be identified and quantified by physical measurements of a printed feature. Defects and distortions can be predicted before, during, or after the printing process. Defect and distortion identification, path distortion, and control systems as described in “Deliberate Defect Introduction in Additive Manufacturing” U.S. Provisional Patent Application No. 63/716,673, “Automated Defect Recognition and Determinations of Pore Cluster Compliance” U.S. patent application Ser. No. 18/929,462, “Real-Time Adaptive Control of Additive Manufacturing Processes Using Machine Learning” U.S. patent application Ser. No. 15/604,473, “Control Architecture for Additive Manufacturing Robotic Systems” U.S. Provisional Patent Application No. 63/552,610, “Methods and Systems for Fabrication of Three-Dimensional Objects” U.S. patent application Ser. No. 16/683,760, and “Systems and Methods for Three-Dimensional Printing” U.S. patent application Ser. No. 17/378,875, hereby incorporated in their entireties by reference.

In some embodiments, the print may be paused after a number of individual deposition layers are deposited. The partial print may be evaluated to determine the physical parameters of the feature being printed. The later deposition layers may be adjusted based on the printed feature parameters if the printed feature parameters, when paused, do not match the predicted feature parameters at the pause point. The evaluation may determine the formation of potential defects and/or distortions not accounted for in the original determination of series of deposition layers. The evaluation may determine predicted defects and/or distortions have not formed. The further deposition layers may be altered before being deposited.

In some embodiments, the adjusted parameters and part parameters evaluated during the printing process may be saved as a part of the printing process data file. The adjusted parameters may be used to better predict distortions and defects in subsequent productions of other features. The evaluated parameters may be incorporated in the prediction determination of potential defects and distortions. Through this feedback loop, the system described herein improves the determination of a series of deposition layers.

In many embodiments, the evaluation during the printing process may be controlled by a technician. The pause point during the printing process may be determined before the print begins, or it may be determined by a technician during the printing process. The parameter adjustment during the printing process may be determined by the technician's evaluation of the feature's parameters. The technician may manually adjust future deposition layer parameters based on the evaluation. In some embodiments, the WAAM consumables may be swapped during a pause point to ensure the print quality is maintained. In some embodiments, the feedstock material may be changed during a pause point.

In several embodiments, the evaluation during the printing process may be conducted automatically. The system may further comprise an image sensor to evaluate a feature during the printing process. The image sensor may determine the feature's physical parameters during the pre-determined pause point. The image sensor may be configured to continually monitor the feature's physical parameters and initiate a print pause. During a print pause, the image sensor may determine the feature's physical parameters. In many embodiments, the system is configured to determine changes to further deposition layers based on the evaluation. In many embodiments the process may comprise both technician and automated evaluation and adjustments.

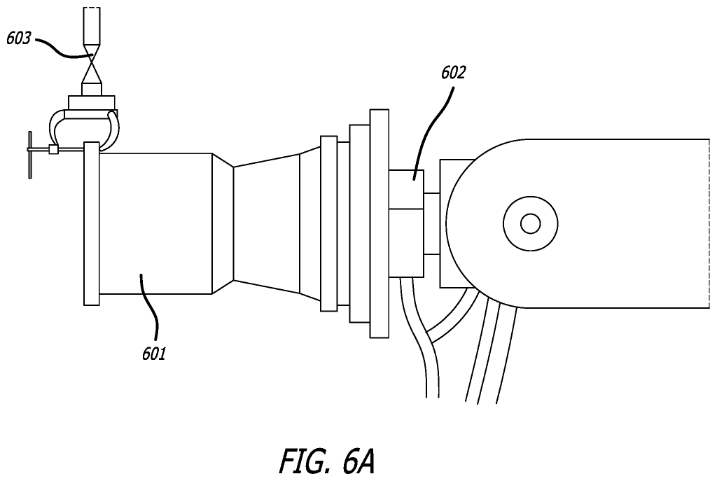

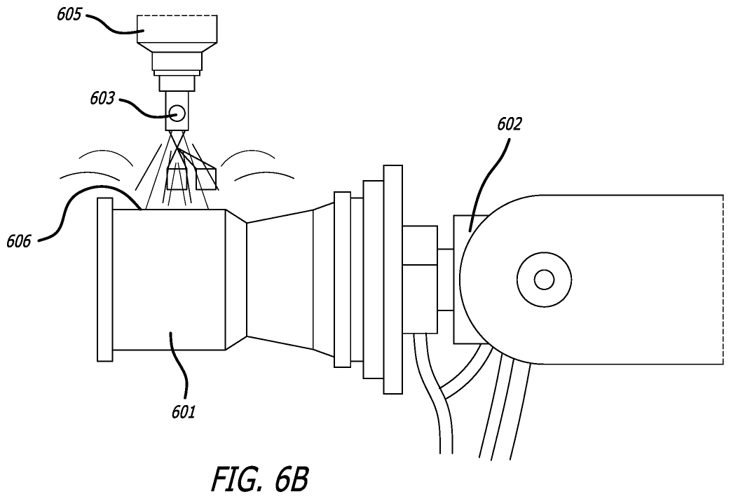

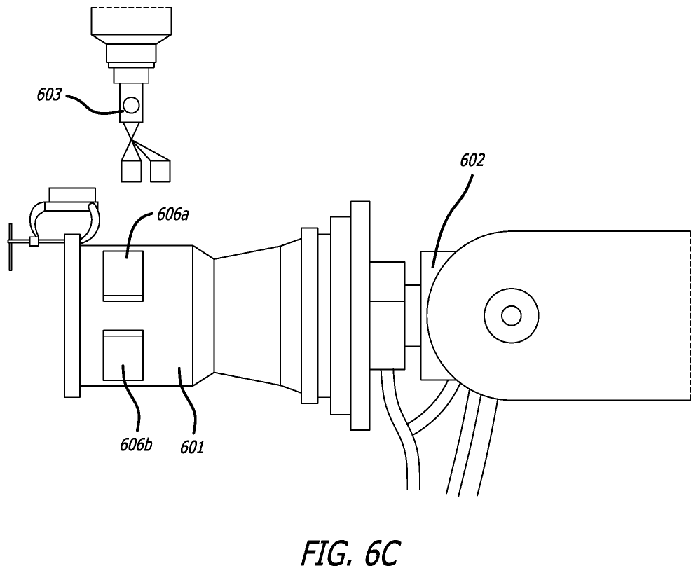

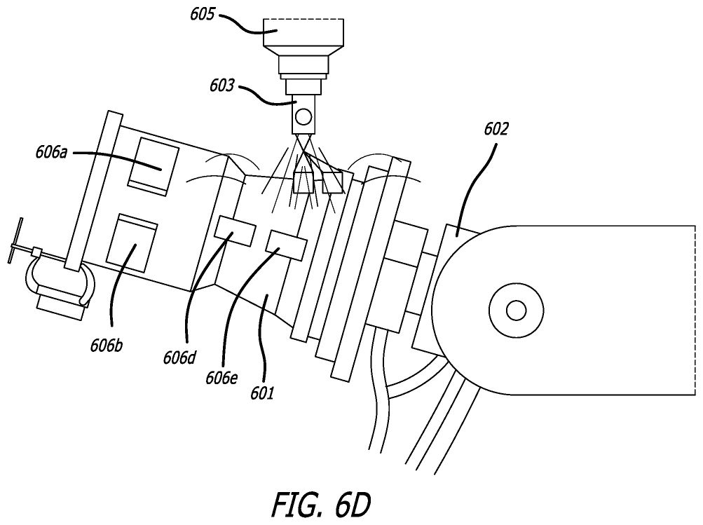

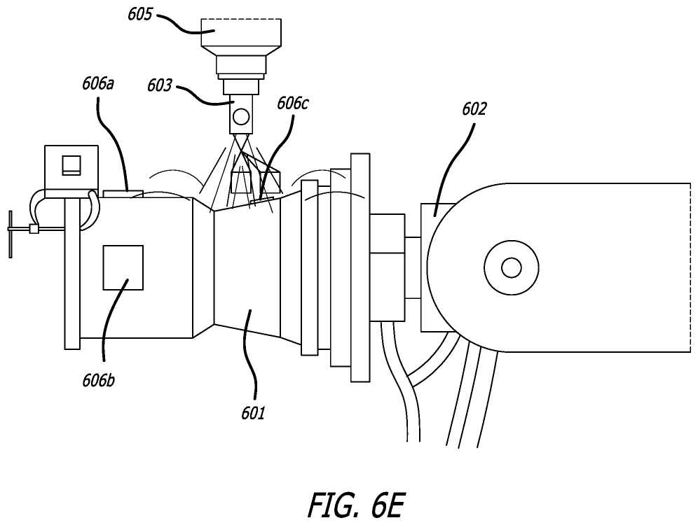

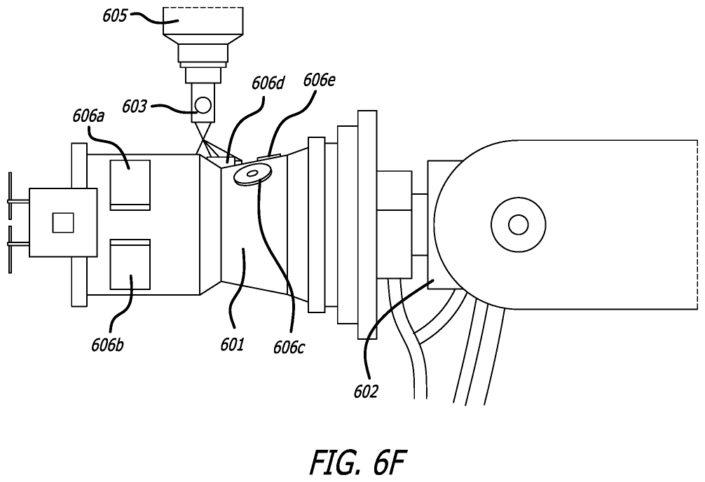

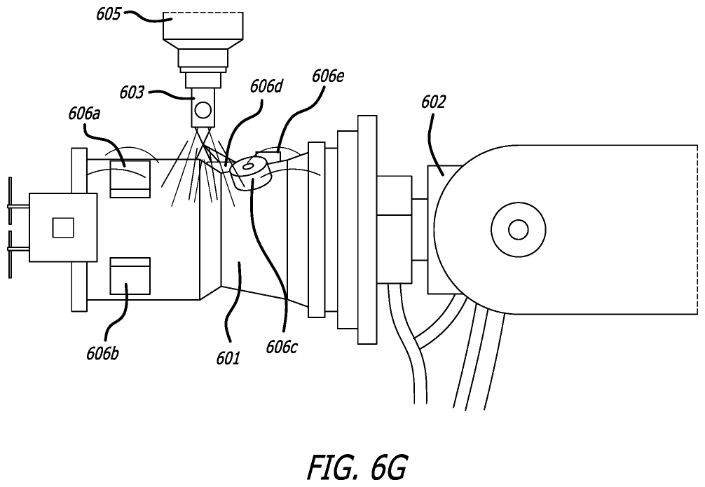

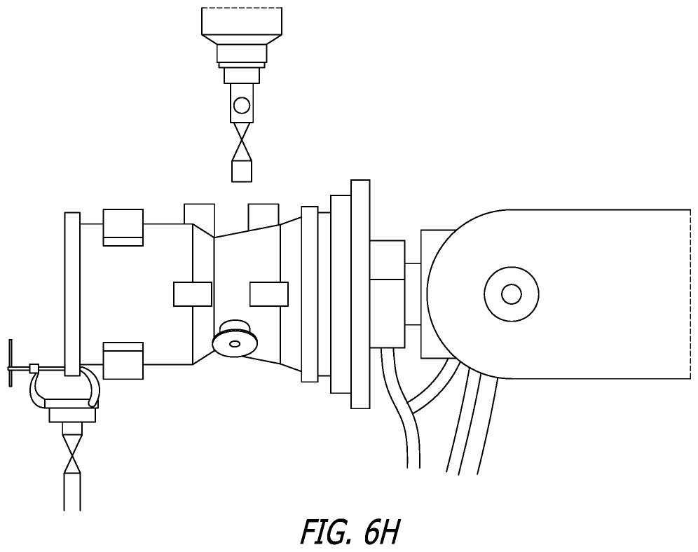

FIGS. 6A to 6H depict an example of an iterative AM system to print AM features printed on a part in accordance with an embodiment. FIGS. 6A to 6H comprise a witness coupon fixture to print a witness coupon as a feature as described in “Additively Manufacture Representative Witness Coupon Techniques” U.S. Ser. No. 19/401,219 filed Nov. 25, 2025, the disclosure of which is incorporated by reference in its entirety. FIG. 6A depicts a curved part 601 without any features mounted on a positioner 602. The weld torch 603 is also mounted on a movable arm 605 (as shown in a following Figure). FIG. 6B depicts the initial printing of a feature 606. FIG. 6C depicts two features 606a, 606b mid print. FIG. 6D illustrates the coordinated movement as additional feature features 606c, 606d, and 606e are printed. The deposition of additional features is optimized by the tilting and rotation of the part 601 by the positioner 602 and the movement of the weld torch 603 by the movable arm 605. FIGS. 6E to 6G depict how during the overall printing process, the AM system may move from one feature to another utilizing a master path. FIG. 6E depicts the weld torch 603 depositing material on a first feature 606c. FIG. 6F depicts the weld torch 603 moved by the movable arm 605 in coordination with the rotation of the part 601 by the positioner 602 to deposit material on a second feature 606d. FIG. 6G depicts the growth of feature 606c after several passes between various feature in accordance with the order of interleaved deposition patterns. The features 606a, 606b have grown significantly in comparison with FIG. 6A and FIG. 6G. FIG. 6H depicts the finished feature components. FIGS. 6B to 6H show the movement and repositioning of the weld torch between different features as it follows the order of interleaved deposition patterns of each of the different features. The weld torch moves back and forth between printing different features in accordance with this master path. The printing process shown in FIGS. 6A to 6G follows a master path to determine the rotation of the part, the retraction of the weld torch, and the orientation of the printing process as the individual features are printed incrementally. During the printing process, the weld torch can be seen to move from one feature to another between FIGS. 6B and 6D.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 200 should be understood to include the explicitly recited limits of about 1 and about 200, but also to include individual ratios such as about 2, about 3, and about 4, sub-ranges such as about 1 to about 10, about 10 to about 50, about 20 to about 100, about 100 to about 200, and so forth, and related ranges such as greater than about 1 or less than about 200.

What is claimed is:

1. A process of additive manufacturing comprising:
providing a geometry of a component to be printed;
providing a substrate;
acquiring a surface geometry of the substrate;
determining a series of individual deposition layers;
printing the component according to the series of individual deposition layers;
pausing the printing of the component with remaining unprinted individual deposition layers in the series;
evaluating a physical characteristics of the component; and
adjusting the remaining unprinted individual deposition layers based on the evaluated physical characteristics.

2. The process of claim 1, wherein the step of evaluating the physical characteristics comprises comparing the physical characteristics with the geometry of the component.

3. The process of claim 1, further comprising saving adjustments to the individual deposition layers.

4. The process of claim 3, wherein the step of saving is performed after the step of pausing.

5. The process of claim 3, wherein the step of determining the series of individual deposition layers comprises adjusting the geometry of the component based on a previous step of saving adjustments to the individual deposition layers.

6. The process of claim 1, wherein the step of determining the series of individual deposition layers comprises adjusting the geometry of the component based on the surface geometry of the substrate.

7. A process of additive manufacturing comprising:
providing one or more component geometries;
printing one or more articles based on the one or more component geometries;
adjusting one or more print parameters;
recording the adjusted one or more print parameters; and
incorporating the recorded adjusted one or more print parameters into the one or more component geometries.

8. The process of claim 7, wherein the step of adjusting one or more print parameters occurs during the step of printing.

9. The process of claim 8, wherein adjusting one or more print parameters comprises evaluating a physical characteristic of the one or more articles.

10. The process of claim 9, further comprising pausing printing one or more articles to evaluate the physical characteristic of the one or more articles.

11. The process of claim 7, further comprising saving the recorded adjusted one or more print parameters.

12. A process of additive manufacturing comprising:
providing a part;
providing one or more component geometries to be incorporated on the part;
determining a series of individual deposition patterns for each component geometry;
determine a plurality of depositions, wherein each deposition comprises the series of the deposition patterns, wherein the plurality of depositions incorporates a coordinated movement between a weld torch and the part; and
printing one or more components on the part by switching between components according to the plurality of depositions.

13. The process of claim 12, further comprising pausing the printing of one or more components to evaluate a physical characteristic of each component.

14. The process of claim 13, further comprising evaluating the physical characteristic each component to adjust one or more print parameters for each component.

15. The process of claim 13, wherein the physical characteristic of each component is saved.

16. The process of claim 15, wherein the saved physical characteristic of each component is compiled to form a print file for each component.

17. The process of claim 16, wherein the print file is incorporated into the component geometry.

18. The process of claim 16, wherein the print file is appended alongside the component geometry.

19. The process of claim 12, wherein the coordinated movement comprises tilting the substrate.

20. The process of claim 12, wherein the coordinated movement comprises tilting the weld torch.
